(19) United States
(12) Patent Application Publication
(10) Pub. No.: US 2025/0217338 A1
(43) Pub. Date: Jul. 3, 2025

(54) Method of enriching a structured database, a method of assisting the piloting of an aircraft, related computer program product and electronic device

(71) Applicant: THALES, Meudon (FR)

(72) Inventors: Thomak LEDUC, Merignac (FR); Wissam SOFIANE, Merignac (FR); Jaime DIAZ-PINEDA, Merignac (FR)

(21) Appl. No.: 19/002,957

(22) Filed: Dec. 27, 2024

(30) Foreign Application Priority Data
Dec. 29, 2023 (FR) 2315489

(51) Int. Cl. G06F 16/215; B64C 13/18

(52) U.S. Cl. CPC G06F 16/215; B64C 13/18

(57) ABSTRACT

The present invention relates to a method for enriching a structured database intended to assist a pilot of an aircraft in decision-making. The method comprises the following steps:
obtaining an initial structured database, called the initial structured base, comprising a plurality of objects,
determination of at least two indicators from the group of indicators consisting of: a frequency indicator, an interconnection indicator, a relevance indicator, and a precision indicator,
comparison of each determined indicator with at least one respective threshold,
if the result of the comparison is negative, sending an enrichment command of the initial structured database to form an enriched structured database, called enriched structured base, comprising a larger number of objects than the initial structured base.

### FIELD

The present invention relates to a method for enriching a structured database. The present invention further relates to an electronic enrichment device configured to implement such a method.

The present invention further relates to a method of pilot-assistance and an electronic system for pilot-assistance.

The present invention further relates to a computer program product apt to implement such methods.

### BACKGROUND

The present invention relates to the field of pilot-assistance systems.

In the field, it is known to use a flight computer to provide data to the pilot of the aircraft. As a general rule, the flight computer stores a database comprising a plurality of data that the pilot of the aircraft is able to consult.

Conventionally, the flight computer displays information on the current and future status of the aircraft on displays, so that the pilot of the aircraft can make the best decisions.

More elaborate versions of flight computers include a human-machine interface with which the pilot is able to interact. For example, the pilot is able to query the databases stored in the flight computer to obtain richer and contextualized data. Thereof is called knowledge. By means of such knowledge, the pilot has a finer understanding of their environment and the situation they encounter. The decisions made by the pilot are then of better quality.

It is clear that the quality of the decisions that the pilot makes then strongly depends on the quality of the knowledge that can be extracted from the database. In other words, the quality of such decisions depends intrinsically on the database as such.

However, it is difficult to assess whether the database is suitable for the intended use.

For example, if the database has too little data, same will not be suited for providing an appropriate response to each situation. On the other hand, if the database contains too much data, a long time is needed to browse through and a number of answers that are far too high for the user to have time to analyze same, might be provided.

In another example, the way in which the database is organized is also of great importance. Indeed, if the database is not properly organized/structured, it may be particularly complex to extract intelligible knowledge therefrom.

There is thus a need for a tool for ensuring that the database in question is sufficiently complete while remaining intelligible for a user to be able to use same.

### SUMMARY

To this end, the present invention relates to a method of enriching a structured database intended to assist a pilot of an aircraft in decision-making, the method being implemented by an electronic device and comprising the following steps:
obtaining an initial structured database, called the initial structured base, comprising a plurality of objects including:
   a plurality of classes,
   a plurality of data, and
   semantic links associating each datum with at least one class, each datum and/or each class comprising one or a plurality of words,
determination of at least two indicators from the group of indicators consisting of:
   a frequency indicator quantifying the frequency of occurrence of each word in the initial structured base,
   an interconnection indicator representative of a distribution of semantic links in the initial structured base,
   a relevance indicator quantifying the usefulness of the data in the initial structured base,
   a precision indicator quantifying the polysemy of each word of the initial structured base,
comparison of each determined indicator with at least one respective threshold,
if the result of the comparison is negative, sending an enrichment command from the initial structured database to form an enriched structured database, called enriched structured base, comprising a larger number of objects than the initial structured base.

By assessing the different indicators, it is possible to ensure that the initial structured base, or the enriched structured database is sufficiently complete in information while limiting the amount of data same contains. Thereby, the structured database resulting from the method according to the invention is optimized so that the use thereof, by a user, is efficient.

According to other advantageous aspects of the invention, the enrichment method comprises one or a plurality of the following features, taken individually or according to all technically possible combinations:
the indicator determination step comprises the determination of at least three indicators from the group of indicators, the step of determination of indicators preferentially including the determination of each indicator from the group of indicators;
one of the indicators determined during the determination step is the frequency indicator, the determination step comprising:
   the calculation of Shannon entropy associated with each word of the initial structured base,
   the evaluation of the percentage of words, the Shannon entropy of which is greater than a respective value,
   the application of a statistical test to Shannon entropies calculated to obtain a p-value and a similarity percentage,
the quantity of information indicator comprising:
   the percentage of words the Shannon entropy of which is greater than the preset value,
   the p-value, and
   the similarity percentage;
one of the indicators determined in the determination step is the interconnection indicator, the determination step comprising:
   the calculation of the proportion of the number of classes in the initial structured base comprising an explanatory comment on the content of the class,
   calculation of the number of semantic links linking each class to a datum in the initial structured base,
   the evaluation of the number of classes linked to data by a number of semantic links less than a respective first value or greater than a respective second value,
   the calculation of a modularity value of the classes of the initial structured base,
the interconnection indicator comprising:
   the number of classes in the initial structured base comprising an explanatory comment of the content of the class,
   the number of classes linked to data by a number of semantic links less than the respective first value or greater than the respective second value, and
   the modularity value of the classes;
one of the indicators determined during the determination step is the precision indicator, the determination step comprising:
   obtaining a dictionary comprising a plurality of words and, for each word, at least one meaning,
   the comparison of each word of each class of the initial structured base to the words of the dictionary,
   the calculation of a percentage of words from the initial structured base appearing in the dictionary,
   among the words appearing in the dictionary, the calculation of a percentage of words with a single meaning in the dictionary,
   the transformation of the initial structured base into a graph, the graph comprising a central class, called the parent class, linked to a plurality of classes, called the daughter classes,
   the calculation of Shannon entropy associated with each daughter class,
   the evaluation of a percentage of daughter classes the Shannon entropy of which is greater than a respective value,
the precision indicator comprising:
   the percentage of words from the initial structured base that appear in the dictionary,
   percentage of words in the initial structured base that have a single meaning in the dictionary,
   the percentage of daughter classes the Shannon entropy of which is greater than the respective value;
the initial structured base comprises a plurality of scenarios each including a set of values and an action taken by the pilot of the aircraft in the presence of the set of values, each value of the set of values being a numerical value of a datum of the initial structured base,
one of the indicators identified during the determination step being the relevance indicator, the determination step comprising:
   obtaining an artificial intelligence model trained to receive a scenario and to determine a logical rule combining the values of the set of values leading to the action of said scenario, and to quantify the importance of each value in the action taken,
   application of said artificial intelligence model to each scenario of the initial structured base, in order to obtain, for each value of each set of values, an importance quantifier in the action of said scenario,
   calculation of the proportion of values in sets of values for which the significance quantifier is below a respective threshold,
the relevance indicator comprising:
   said proportion of values of the sets of values for which the significance quantifier is less than the respective threshold;
following the step of sending an enrichment command, the steps of obtaining, determining, comparing and, where appropriate, sending, of the method are reiterated as long as the result of the comparison is negative,
the enriched structured base of one iteration being the initial structured base of the next iteration,
the structured database obtained at the end of the iterations being called the validated structured base; and
The method comprises, if the result of the comparison is positive, a step of importing the validated structured base, into an electronic device for interaction with the pilot of the aircraft, for the use thereof during an aircraft mission.

A further subject matter of the invention is a method for assisting the piloting of an aircraft, from an initial structured database, called the initial structured base, the method comprising an enrichment phase and an operation phase,
the enrichment phase comprising enrichment of the initial structured base by the application of such an enrichment method,
the use phase being implemented by an electronic device for interaction with the pilot of the aircraft, the interaction electronic device comprising the structured database resulting from the enrichment phase, called the validated structured base, and comprising the following steps:
   reception of a request from the pilot of the aircraft,
   selection of objects, from the validated structured database, in response to the request received,
   transmission of a flight instruction elaborated from the selected objects, to one amongst: the pilot of the aircraft and an actuator of the aircraft.

A further subject matter of the invention is a computer program product, comprising software instructions which, when executed by a computer, implement such a method.

A further subject matter of the invention is an electronic device for enriching a structured database intended to assist a pilot of an aircraft in decision-making, the electronic enrichment device comprising:
an obtaining module configured to obtain an initial structured database, called initial structured base, comprising a plurality of objects including:
   a plurality of classes,
   a plurality of data, and
   semantic links associating each datum with at least one class,
each datum and/or each class comprising one or a plurality of words,
a determination module configured to determine at least two indicators from the group of indicators consisting of:
   a frequency indicator quantifying the frequency of occurrence of each word in the initial structured base,
   an interconnection indicator representative of a distribution of semantic links in the initial structured base,
   a relevance indicator quantifying the usefulness of the data in the initial structured base,
   a precision indicator quantifying the polysemy of each word of the initial structured base,
a comparison module configured to compare each determined indicator with at least one respective threshold,
a sending module configured to, if the result of the comparison is negative, send an enrichment command of the initial structured database to form an enriched structured database, called enriched structured base, comprising a larger number of objects than the initial structured base.

A further subject matter of the invention is an electronic device for enriching a structured database intended to assist a pilot of an aircraft in decision-making, the electronic enrichment device comprising:
an obtaining module configured to obtain an initial structured database, called initial structured base, comprising a plurality of objects including:
   a plurality of classes,
   a plurality of data, and
   semantic links associating each datum with at least one class,
each datum and/or each class comprising one or a plurality of words,
a determination module configured to determine at least two indicators from the group of indicators consisting of:
   a frequency indicator quantifying the frequency of occurrence of each word in the initial structured base,
   an interconnection indicator representative of a distribution of semantic links in the initial structured base,
   a relevance indicator quantifying the usefulness of the data in the initial structured base,
   a precision indicator quantifying the polysemy of each word of the initial structured base,
a comparison module configured to compare each determined indicator with at least one respective threshold,
a sending module configured to, if the result of the comparison is negative, send an enrichment command of the initial structured database to form an enriched structured database, called enriched structured base, comprising a larger number of objects than the initial structured base.

A further subject matter of the invention is an electronic system for assisting the piloting of an aircraft from an initial structured database, called the initial structured base, the system comprising an electronic enrichment device comprising:
an obtaining module configured to obtain an initial structured database, called initial structured base, comprising a plurality of objects including:
   a plurality of classes,
   a plurality of data, and
   semantic links associating each datum with at least one class,
each datum and/or each class comprising one or a plurality of words,
a determination module configured to determine at least two indicators from the group of indicators consisting of:
   a frequency indicator quantifying the frequency of occurrence of each word in the initial structured base,
   an interconnection indicator representative of a distribution of semantic links in the initial structured base,
   a relevance indicator quantifying the usefulness of the data in the initial structured base,
   a precision indicator quantifying the polysemy of each word of the initial structured base,
a comparison module configured to compare each determined indicator with at least one respective threshold,
a sending module configured to, if the result of the comparison is negative, send a command to enrich the initial structured database in order to form an enriched structured database, called enriched structured base, comprising a larger number of objects than the initial structured base,
   the system further comprising an electronic device for interaction with a pilot of the aircraft, the electronic device for interaction including the structured database resulting from the enrichment module phase, called the validated structured base, and comprising:
a receiver module configured to receive a request from the aircraft pilot,
a selection module configured to select objects from the validated structured base in response to the received request,
a transmission module configured to transmit a piloting instruction developed from the selected objects, to one amongst: the pilot of the aircraft and an actuator of the aircraft.

### BRIEF DESCRIPTION OF THE DRAWINGS

The invention will be clearer upon reading the following description, given only as an example, but not limited to, and making reference to the drawings wherein:

FIG. 1 is a diagram of a pilot-assistance electronic system according to the invention,

FIG. 2 is a schematic representation of a structured database used by the electronic system according to the invention,

FIG. 3 is a visual representation of a frequency indicator determined by an electronic enrichment device of the electronic system for assistance in decision-making shown in FIG. 1,

FIG. 4 is a visual representation of an element determined by an electronic enrichment device of the electronic system for assistance in decision-making shown in FIG. 1,

FIG. 5 is a visual representation of an element determined by an electronic enrichment device of the electronic system for assistance in decision-making shown in FIG. 1,

FIG. 6 is an organization chart of a pilot-assistance method implemented by the system for assistance in decision-making shown in FIG. 1.

### DETAILED DESCRIPTION

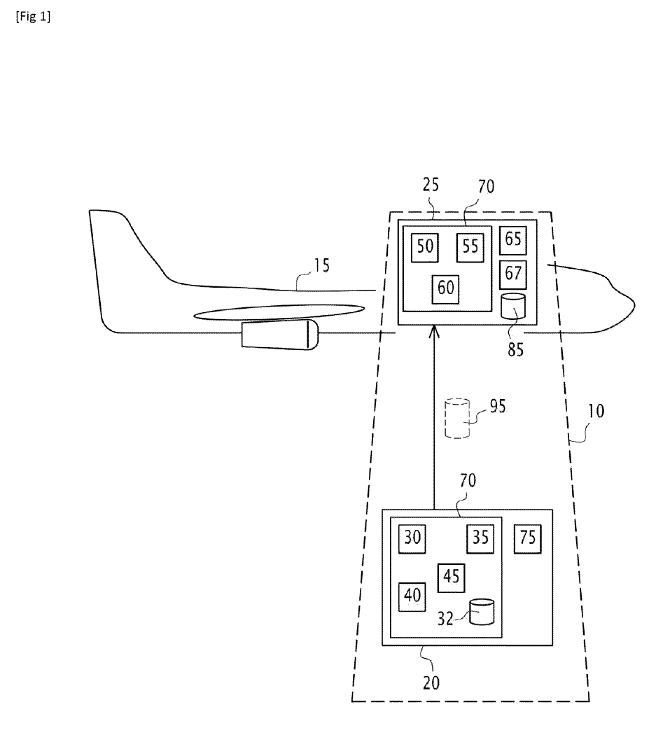

FIG. 1 shows an electronic system 10 for assistance in piloting an aircraft 15.

The system 10 comprises an electronic device 20 for enriching a structured database which will be described hereinafter, and an electronic device 25 for interacting with a pilot of the aircraft 15.

The enrichment device 20 is preferably remote from the aircraft 15.

The enrichment device 20 comprises a module 30 for obtaining an initial structured database 32, called the initial structured base 32, a module 35 for determining indicators which will be described hereinafter, a module 40 for comparing the determined indicators with respective thresholds, and a sending module 45.

The interaction device 25 is preferably carried on-board the aircraft 15.

The interaction device 25 comprises a module 50 for receiving a request from a pilot of the aircraft 15, a selection module 55 and a transmission module 60.

In the example shown in FIG. 1, the electronic enrichment device 20 and the electronic interaction device 25 respectively comprise a first and a second information processing unit.

The first information processing consists e.g. of a first memory 70 and of a first processor 75 associated with the first memory 70.

In the example shown in FIG. 1, the obtaining module 30, the determination module 35, the comparison module 40 and the sending module 45 are each implemented in the form of a software program, or a software brick, which can be executed by the second processor 75. The first memory 70 of the electronic enrichment device 20 is then apt to store an obtaining software, a determination software, a comparison software and a sending software. The first processor 75 is then apt to execute each of the software programs among the obtaining software, the determination software, the comparison software, and the sending software.

Similarly, the second information processing unit consists e.g. of a second memory 80 and of a second a processor 85 associated with the second memory 80.

The obtaining module 1, the reception module 50, the selection module 55 and the transmission module 60 are each produced in the form of a software program, or a software brick, which can be executed by the second processor 85. The second memory 80 of the electronic device for interaction 25 is then apt to store a reception software, a selection software and a transmission software. The second processor 85 is then apt to execute each of the software programs among the reception software, the selection software, and the transmission software.

In a variant (not shown), the obtaining module 30, the determination module 35, the comparison module 40, the sending module 45, and, as an optional supplement, the reception module 50, the selection module 55 and the transmission module 60 are each produced in the form of a programmable logic component, such as an FPGA (Field Programmable Gate Array), or else in the form of an integrated circuit, such as an ASIC (Application Specific Integrated Circuit).

When the electronic enrichment device 20 and the electronic device for interaction 25 are produced in the form of one or a plurality of software programs, respectively, i.e. in the form of a computer program, also called a computer program product, same are further apt of being saved on a computer-readable medium (not shown). The computer-readable medium is e.g. a medium apt to store the electronic instructions and to be coupled to a bus of a computer system. As an example, the readable medium is an optical disk, a magneto-optical disk, a ROM, a RAM, any type of non-volatile memory (e.g. FLASH or NVRAM) or a magnetic card. A computer program containing software instructions is then stored on the readable medium.

Preferentially, the interaction device 25 further comprises a display screen 65 and/or a keyboard 67 so that the pilot can communicate a request to the interaction device 25.

The obtaining module 30 is configured to obtain the initial structured database 32, called the initial structured base 32.

In the present application, the term structured database refers to a database comprising a plurality of objects amongst which: a plurality of classes, a plurality of data, also called class instances, and semantic links associating each datum with at least one class.

Preferentially, the initial structured base 32 is an ontology.

Each class data/instance, and each class, comprises one or a plurality of words. Preferentially, each class and each class instance is a nominal group.

In the present application, the term “class instance” refers to a datum intended to qualify or quantify an aspect of a class.

Preferentially, certain semantic links also connect two classes together, to indicate a dependency link between the two classes.

By means of the semantic links, it is possible to represent the initial structured base 32 in the form of a graph.

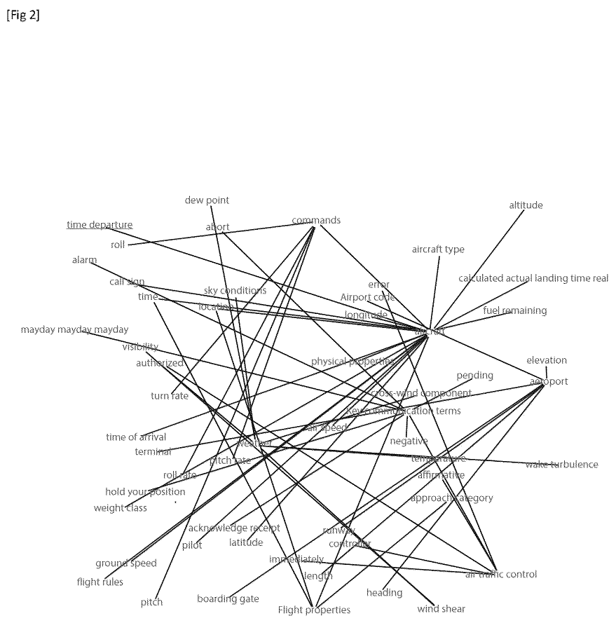

FIG. 2 shows an example of an initial structured base 32 comprising the following classes: “aircraft”, “physical properties”, “air traffic control”, “location”, “approach category”, “flight properties”, “call sign”, “controller”, “time”, “air speed”, “altitude”, and “time of arrival”.

In such example, the different class instances are the following: “abort”, “key terms in communication”, “acknowledge reception”, “calculated actual landing time”, “affirmative”, “aircraft type”, “alert”, “authorized”, “commands”, “cross-wind component”, “weather”, “departure time”, “dew point”, “elevation”, “airport” “error”, “flight rules”, “remaining fuel”, “(boarding) gate”, “terminal”, “ground speed”, “heading”, “runway”, “mayday mayday mayday”, “negative”, “pilot”, “pitch”, “pitch rate”, “roll”, “roll rate”, “sky conditions”, “pending”, “temperature”, “turn rate”, “visibility”, “wake turbulence”, “weight class”, et “wind shear”.

In FIG. 2, semantic links are represented by continuous lines connecting a class to a class instance, or two classes to each other.

In a manner not shown, in the initial structured base 32, at least one class and preferably a plurality of classes comprise an explanatory comment of the content of the class. In the preceding example, an explanatory comment for the class is e.g. “an aircraft has latitude and is at the airport.” Optionally, at least some class data/instances correspond to quantifiable physical parameters. In the preceding example, the class data/instances are e.g. the following: “air velocity”, “altitude”, “location”, “cross wind component”, “dew point”, “elevation”, “ground speed”, “heading”, “latitude”, “length”, “longitude”, “pitch”, “roll”, “temperature”, “turn rate”, and “wind shear”.

The initial structured base 32 optionally comprises a plurality of scenarios each including a set of values and an action taken by the pilot of the aircraft 15 in the presence of the set of values. Each value of the set of values is a numerical value of a datum of the initial structured base 32. Preferentially, each value of a set of values is a numerical value of a class instance corresponding to a physical parameter. Thereby, the class instance and the associated value form an item of knowledge.

As an example, a scenario is during a landing, an evaluation of the release of an aircraft, the proposed module evaluates the following class instances: air speed, altitude and roll of aircraft class; the cross-wind component and the shear of the wind coming from weather class; the heading of the airport runway.

For example, from an operational point of view, if the situation returns non-nominal physical parameters (and the interactions thereof), the operator is to perform an overshoot of the aircraft. More precisely, if the aircraft is not aligned through the roll thereof to the runway, and/or if the aircraft has an air speed greater than the recommended landing speed (20% higher than the regulations in force), and/or if the wind shear or cross-wind component is too high (15% higher than the regulations), the pilot is asked to overshoot.

Preferentially, the obtaining module 30 is configured to receive the initial structured base 32 from a user of the enrichment device 20.

The determination module 35 is configured to determine at least two indicators from the group of indicators consisting of: a frequency indicator quantifying a frequency of occurrence of each word in the initial structured base 32, an interconnection indicator representative of a distribution of semantic links in the initial structured base 32, a relevance indicator, and a precision indicator quantifying the polysemy of each word of the initial structured base 32.

Preferentially, the determination module 35 is configured to determine at least three indicators of said group of indicators.

More preferentially, the determination module 35 is configured to determine each indicator of said group.

The frequency indicator serves to quantify whether the words present in the initial structured base 32 are semantically sufficiently distinct from each other and thereby to make sure that same does not have too many synonyms that could impair the intelligibility of the initial structured base 32.

To determine the frequency indicator, the determination module 35 is preferentially configured to calculate the Shannon entropy associated with each word of the initial structured base 32.

To this end, the determination module 35 is configured e.g. to calculate for each word of the initial structured base 32 a similarity score with each other word of the structured database 32. The determination module 35 is configured e.g. to use a “sentence transform” model to associate a vector of numerical values with each word, and to calculate the similarity score between two words as being a normalized scalar product between the vectors associated with each of the two words. The “sentence transformers” model is e.g. derived from the Universal sentence encoder tool from Google®.

Preferentially, the Shannon entropy is calculated according to the following formula:

$$Q ( m ) = - {\sum }_{n} P ( m , n ) * {log}_{2} ( P ( m , n ) ) \qquad [ MATH 1 ]$$

where m is a word present in the initial structured base 32,
Q(m) is the Shannon entropy of the word m,
P(m, n) is the similarity score between the word m and the word n, and
log₂(·) is the logarithmic function in base 2.

Else preferentially, the determination module 35 is configured to then evaluate the percentage of words, in the initial structured base 32, the Shannon entropy of which is greater than a first predefined value. The first predefined value is e.g. equal to 5%.

The determination module 35 is configured to then apply a statistical test to the Shannon entropies calculated to obtain a p-value and a similarity percentage. The statistical test is e.g. a Student test known per se.

Preferentially, the determination module 35 is configured to obtain, during the application of the Student test, for each word of the initial structured base 32, a similarity score, e.g. comprised between 0 and 1. The determination module 35 is then configured to calculate the similarity percentage as being the percentage of initial structured base words 32 the similarity score of which is greater than a second predefined value. The second predefined value is e.g. equal to 0.8.

The p-value quantifies whether the initial structured base 32 has enough classes.

The similarity percentage quantifies whether the initial structured base 32 does not include too many classes.

The determination module 35 is then configured to determine the frequency indicator as comprising the percentage of words the Shannon entropy of which is greater than the first predefined value, the p-value, and the similarity percentage.

In the preceding example, the percentage of words the Shannon entropy of which is greater than the first predefined value is 5%, the p-value is 4.50418514748828×10⁻¹⁷, and the similarity percentage is 0.4563605248146035.

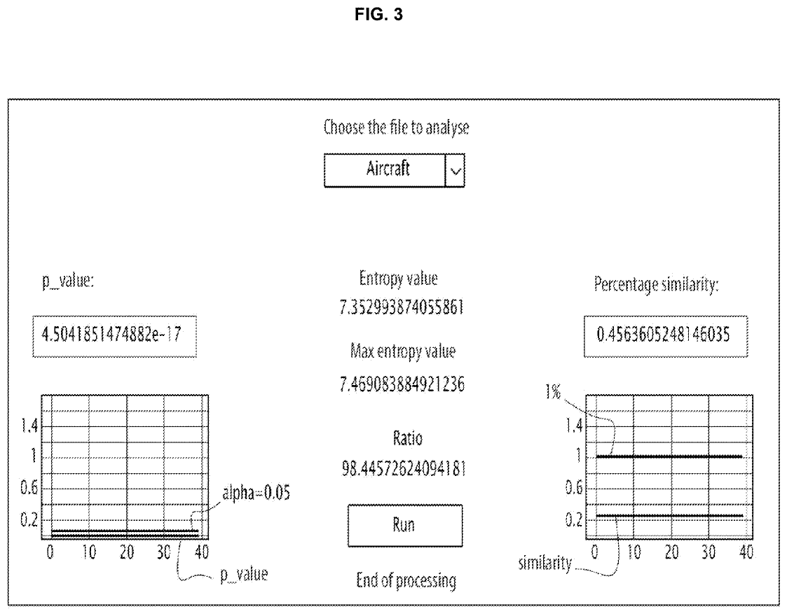

FIG. 3 shows an example of a computer window representing said results.

In FIG. 3, “entropy value” corresponds to the sum of the calculated entropies. Still in FIG. 3, “max entropy value” corresponds to said sum if all similarity scores were equal to 0.5, i.e. if all words were substantially similar. Still in FIG. 3, “ratio” corresponds to the ratio between “entropy value” and “max entropy value”.

The interconnection indicator quantifies whether the class instances are well distributed among the classes of the initial structured base 32. Indeed, a structured base comprising a strongly predominant class comprising almost all class instances would prove difficult to navigate since same would require the passage through too many branches.

To determine the interconnection indicator, the determination module 35 is preferentially configured to calculate the proportion of the number of classes of the initial structured base 32 comprising an explanatory comment of the content of the class.

Preferentially, the determination module 35 is further configured to calculate the number of semantic links linking each class to a datum/class instance in the initial structured base 32. The number of semantic links quantifies the number of class instances associated with each class.

Optionally, the determination module 35 is further configured to evaluate the number of classes linked to data/class instances by a number of semantic links less than a respective first value, called the third predefined value, or greater than a respective second value, called the fourth predefined value.

To this end, the determination module 35 is preferably configured to sort the classes according to the number of semantic links connecting said class to a class instance.

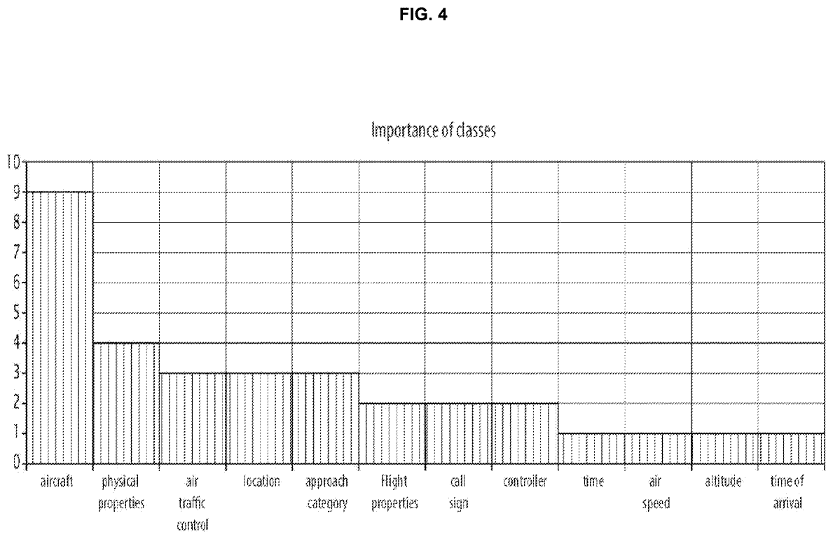

FIG. 4 shows a histogram of the classes sorted in the preceding example of the initial structured base 32. The abscissa in FIG. 4 represents the classes of the initial structured base 32. The ordinate in FIG. 4 represents the number of class instances associated with each class, i.e. the number of semantic links linking that class to a class instance.

Still for this end, the determination module 35 is preferably configured to calculate a box plot on the number of said links per class.

The third value then corresponds to the value of the first quartile, and the fourth value corresponds to the value of the third quartile. In other words, the determination module 35 is preferentially configured to determine the number of classes of the initial structured base 32, the number of instances of which is not between the first and the third quartile.

In the preceding example, the number of classes is equal to 2, i.e. 16.67% of the classes.

The determination module 35 is also configured to calculate the modularity of the classes of the initial structured base 32.

To this end, the determination module 35 is configured, e.g., to apply the Louvain algorithm, known per se. The Louvain algorithm serves to form clusters of classes and instances and provides a modularity value comprised between −1 and 2.1.

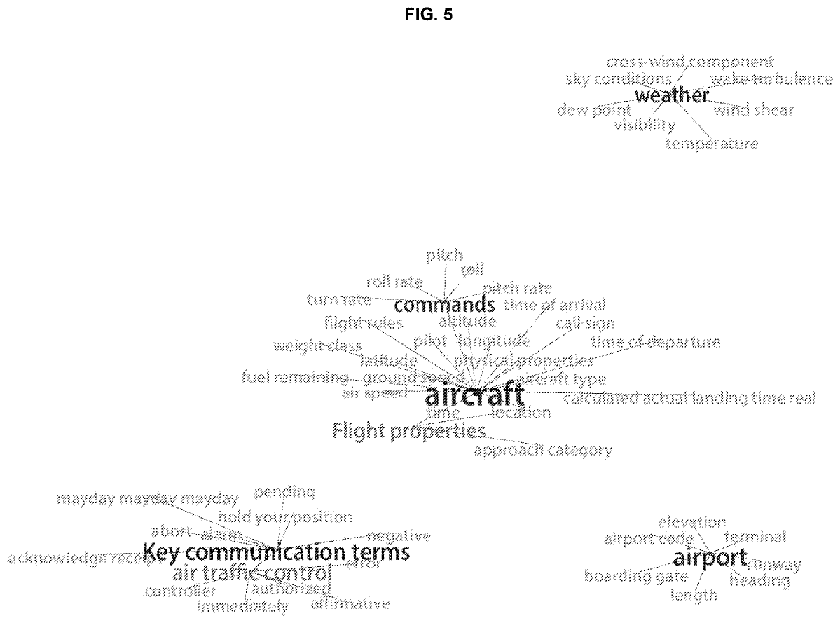

FIG. 5 shows an example of the clusters of classes and instances from the Louvain algorithm applied to the preceding example. As shown in FIG. 5, the most important classes in each cluster, i.e. the classes connected by more semantic links in each cluster, are represented in bold with a larger font than other classes and class instances. In FIG. 5, the central classes are: “aircraft”, “flight properties”, “commands”, “weather”, “airport”, “key communication terms”, and “air traffic control”.

The modularity value quantifies the random character of the semantic links between classes and class instances, or between pairs of class. The higher the modularity value, the less random the semantic links are, i.e. the more well organized same are. In the preceding example and with reference to FIG. 5, the modularity value is equal e.g. to 0.7.

The determination module 35 is preferentially configured to determine the interconnection indicator as comprising: the proportion of the number of classes of the initial structured base 32 comprising an explanatory comment of the content of the class, the number of classes linked to data by a number of semantic links less than the third predefined value or greater than the fourth predefined value (preferentially the result of the box plot), and the modularity value of the classes.

The precision indicator quantifies the extent to which the data of the initial structured base 32 are unambiguously understandable.

To determine the precision indicator, the determination module 35 is preferentially configured to obtain a dictionary comprising a plurality of words and, for each word, at least one meaning. The dictionary (not shown) is e.g. stored in the first memory 70. The dictionary is e.g. the World Net dictionary known per se.

The determination module 35 is configured to then compare each word of each class of the initial structured base 32 with the words of the dictionary, and to calculate a percentage of words of the initial structured base 32 appearing in the dictionary. Optionally, the determination module 35 is configured [to compare] each word of the initial structured base 32, i.e. the instances of classes included, to the words of the dictionary.

The determination module 35 is preferentially configured to calculate, among the words appearing in the dictionary, a percentage of words having a single meaning in the dictionary.

The determination module 35 is also optionally configured to transform the initial structured base 32 into a graph, e.g. as shown in FIG. 2. The graph comprises at least one central class, called the parent class, linked to a plurality of classes, called the daughter classes. In the preceding example, the parent classes are “aircraft”, “weather”, “key terms in communication”, and “airport”, as shown in FIG. 5.

The determination module 35 is optionally configured to then calculate the Shannon entropy associated with each daughter class as described hereinabove by replacing each word with the name of a daughter class.

The determination module 35 is then configured to evaluate a percentage of daughter classes the Shannon entropy of which is greater than a respective predefined value, i.e. fifth predefined value.

The determination module 35 is preferentially configured to determine the precision indicator as comprising the percentage of words of the initial structured base 32 appearing in the dictionary, the percentage of words of the initial structured base 32 having a single meaning in the dictionary, and the percentage of daughter classes the Shannon entropy of which is greater than the fifth predefined value.

The relevance indicator quantifies how important each data/class instance is for decision making. If the initial structured database 32 comprises too many data/instances of classes the usefulness of which is low for decision-making, same will be particularly cumbersome to manipulate.

To determine the relevance indicator, the determination module 35 is configured to obtain an artificial intelligence model trained to receive a scenario and to determine a logical rule combining the values of the set of values leading to the action of said scenario, and to quantify the importance of each value in the action taken.

More particularly, said model is preferably configured to quantify the importance of each knowledge, i.e. of the class instance having the corresponding value of the set of values.

Preferably, said model is a “Logic Tensor Networks” model, also called the LTN model, known per se and described in particular in the Article “Logic Tensor Networks: Deep Learning and Logical reasoning from Data and Knowledge” by Serafini et al.

Such a model is e.g. a neural network trained on a plurality of historical scenarios. The logic rules that the LTN model is suitable for determining comprise e.g. only elementary operators such as “greater than”, “less than”, “AND”, “OR”, “NOT” and “IMPLIES”.

The LTN model is preferentially stored in the first memory 70.

The determination module 35 is configured to apply said LTN model to each scenario of the initial structured base, to obtain, for each value of each set of values, i.e. for each knowledge, an importance quantifier in the action of said scenario. For example, each importance quantifier is a value comprised between 0 and 1. An importance quantifier close to 0 corresponds to a knowledge of little importance, while an importance quantifier close to 1 corresponds to a very important knowledge.

The determination module 35 is configured to calculate the proportion of values of the sets of values for which the importance quantifier is less than a respective threshold, i.e. the sixth predefined threshold. The sixth predefined threshold is e.g. equal to 0.2.

The relevance indicator comprises said proportion of values of the sets of values for which the importance quantifier is less than the respective threshold. In other words, the relevance indicator includes the proportion of knowledge, derived from scenarios, the importance quantifier of which is below the sixth predefined threshold.

The comparison module 40 is configured to compare each determined indicator with at least one respective threshold.

When the/or each determined indicator comprises a plurality pf values, said comparison is considered to be the comparison of each value of said indicator with a respective threshold value.

More particularly, for the frequency indicator, the respective threshold of the percentage of words the Shannon entropy of which is greater than the first predefined value is e.g. equal to 0.002. Still for the frequency indicator, the respective threshold of the p-value is e.g. equal to 0.05, i.e. the result of the comparison is positive if the p-value is less than 0.05, and negative otherwise. Still for the frequency indicator, the respective threshold of the percentage of similarity is e.g. 0.8, i.e. the result of the comparison is positive if the p-value is greater than 0.8.

For the interconnection indicator, the respective threshold of the proportion of the number of classes comprising an explanatory comment of the content of the class is equal to 80%, i.e. the result of the comparison is positive if the proportion of the number of said classes is greater than the threshold, and negative otherwise. Still for the interconnection indicator, the respective threshold of the number of classes linked to data by a number of semantic links less than the third predefined value or greater than the fourth predefined value is preferentially defined by the first and third quartiles of the numbers of connections between the different classes, i.e. the result of the comparison is positive if the number of said classes is comprised between the quartiles, and negative otherwise. For example, if the “airport” class has three connections, it is checked whether the class is between the first and third quartiles of the dataset that corresponds to all the connections of each class.

Still for the interconnection indicator, the respective threshold of the modularity value of the classes is e.g. equal to 0, i.e. the result of the comparison is positive if the modularity value is greater than the threshold, and negative otherwise.

For the precision indicator, the respective threshold of the percentage of words of the initial structured base 32 appearing in the dictionary is e.g. equal to 80%, i.e. the result of the comparison is positive if said percentage is greater than the threshold, and negative otherwise. Still for the precision indicator, the respective threshold of the percentage of words of the initial structured base 32 having a single meaning in the dictionary is e.g. equal to 80%, i.e. the result of the comparison is positive if said percentage is greater than the threshold, and negative otherwise. Still relating to the precision indicator, the respective threshold of the percentage of daughter classes the Shannon entropy of which is less than the fifth predefined value is e.g. 80%, i.e. the result of the comparison is positive if said percentage is greater than the threshold, and negative otherwise.

For the relevance indicator, the respective threshold of the proportion of knowledge the quantifier of which is less than the sixth predefined threshold and e.g. equal to 66%, i.e. the result of the comparison is positive if said proportion is greater than the threshold, and negative otherwise.

The comparison module 40 is preferentially configured to return a negative result if the comparison of at least one of the indicators, or of at least one value of at least one indicator, with the respective threshold, returns a negative result. It is clear that the comparison module 40 is then configured to return a positive result only if the comparison of each indicator, i.e. of each value of each indicator, with the respective threshold, returns a positive result.

The sending module 45 is configured, if the result of the comparison is negative, to send a command to enrich the initial structured database 32 in order to form an enriched structured database, called an enriched structured base, comprising a larger number of objects than the initial structured base 32.

The sending module 45 is e.g. configured to send the enrichment command to a user of the enrichment device 20 so that they manually enrich the initial structured base 35, e.g. by adding one or a plurality of classes, class instances and/or semantic links. In a variant, the sending module 45 is configured to send the enrichment command to an automatic enrichment system (not shown). Such an automatic system is e.g. configured to concatenate the initial structured base 32 with another structured database, e.g. found on the Internet, to form the enriched structured base.

In the preceding example, an enrichment optionally comprises the addition of the data “remaining fuel”, “aircraft”, and “airport”, “communication” and semantic links linking the data to the “alert+” datum which then becomes a class of the enriched structured base.

The enrichment device 20 is preferentially configured to repeat the actions of the modules 30, 35, 40, 45 thereof from the enriched structured base, rather than from the initial database 32.

If during an iteration the result of the comparison is positive, the sending module 45 is configured to send the initial structured base 32 to the interaction device 25, preferentially intended for the storage thereof in the second memory 80. It is clear that if the current iteration is another iteration than the first, the initial structured base 32 considered is the enriched structured base resulting from the preceding iteration. Thereby, the structured database that the sending module 45 is configured to send will subsequently be called the validated structured base 95

The interaction device 25 will now be described.

As indicated hereinabove, the interaction device 25 stores the validated structured base 95 obtained from the sending module 45.

The receiver module 50 is configured for receiving a request from the pilot of the aircraft 15. For example, the request is a sentence such as “find the list of destination airports according to my remaining fuel and the weather at destination”.

To this end, the pilot enters his/her request via e.g. the keyboard 67. Alternatively, if the interaction module 25 comprises a microphone, the pilot returns his/her request to the interaction device 25 by stating same vocally.

The selection module 55 is configured to select objects from the validated structured base 95 in response to the request received. Preferentially, the selection module 55 is configured to select, in the validated structured base 95, the class(es), class instances and, if appropriate, class instance values concerned in a manner known per se. The selection module 55 is configured to generate a piloting instruction from the identified objects.

The transmission module 60 is configured to transmit the piloting instruction elaborated from the selected objects, to one amongst: the pilot of the aircraft 15, and an actuator of the aircraft 15.

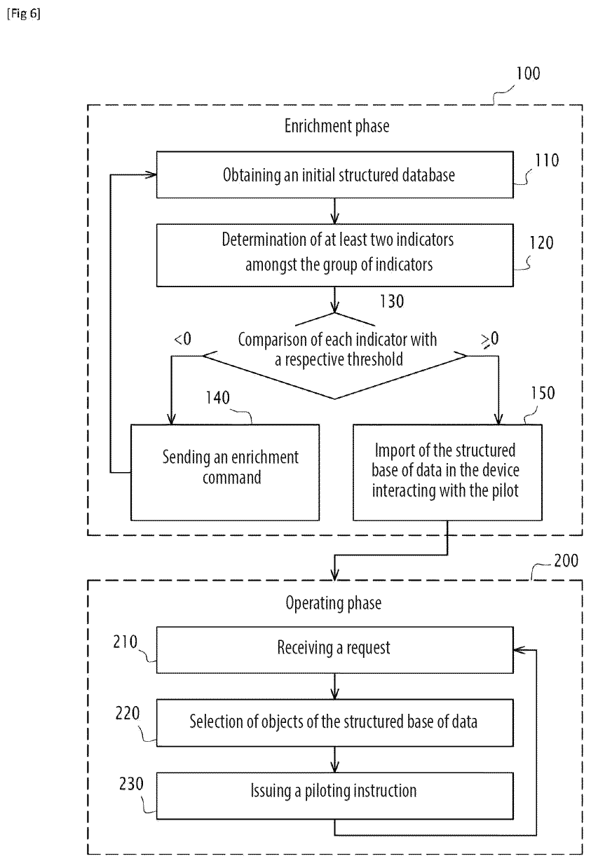

The operation of the pilot-assistance system 10 will be described with reference to FIG. 6 representing a flowchart of a pilot-assistance method according to the invention.

The pilot-assistance method comprises an enrichment phase 100 and an operating phase 200.

Preferentially, the configuration phase 100 is implemented prior to the flight of the aircraft 15. The enrichment phase 100 is e.g. implemented in a design office.

The enrichment phase 100 is preferentially implemented by the enrichment device 20 and comprises the implementation of an enrichment method 100.

The enrichment method 100 comprises a step 110 of obtaining the initial structured base 32.

The enrichment method 100 further comprises a step 120 of determining at least two indicators from the group of indicators consisting of: the frequency indicator, the interconnection indicator, the relevance indicator, and the precision indicator.

Preferentially, the step 120 of determining the indicators comprises the determination of at least three indicators from the group of indicators. More preferentially, the step 120 of determining the indicators comprises the determination of each indicator of the group of indicators.

If, during the determination step 120, one of the determined indicators is the frequency indicator, the determination step 120 then comprises the calculation of the Shannon entropy associated with each word of the initial structured base 32. The determination step 120 further comprises the evaluation of the percentage of words the Shannon entropy of which is greater than the respective value (first predefined value). The determination step 120 further comprises the application of the statistical test to the Shannon entropies calculated to obtain the p-value and the percentage of similarity. Such actions implemented during the determination step 120 are preferentially as explained hereinabove with reference to the determination module 35.

The information quantity indicator then comprises the percentage of words the Shannon entropy of which is greater than the respective value (i.e. first predefined value), the p-value, and the similarity percentage.

If, during the determination step 120, one of the determined indicators is the interconnection indicator, the determination step comprises the calculation of the proportion of the number of classes of the initial structured base 32 comprising an explanatory comment of the content of the class. The determination step 120 further comprises the calculation of the number of semantic links linking each class to a datum/class instance in the initial structured base 32. The determination step 120 further comprises the evaluation of the number of classes linked to data/class instance by a number of semantic links less than a first respective value (third predefined value) or greater than a second respective value (fourth respective value). The determination step 120 further comprises a calculation of the modularity of the classes of the initial structured base 32. Such actions implemented during the determination step 120 are preferentially as explained hereinabove with reference to the determination module 35.

The interconnection indicator comprises the number of classes of the initial structured base 32 comprising an explanatory comment of the content of the class, the number of classes linked to data/class instances by a number of semantic links less than the respective first value (third predefined value) or greater than the respective second value (fourth predefined value), and the modularity value of the classes.

If, during the determination step 120, one of the determined indicators is the precision indicator, the determination step 120 comprises obtaining the dictionary. The determination step 120 further comprises the comparison of each word of each class of the initial structured base 32 with the words of the dictionary. The determination step 120 further comprises the calculation of the percentage of words of the initial structured base 32 appearing in the dictionary. The determination step 120 further comprises the calculation, among the words appearing in the dictionary, of the percentage of words having a single meaning in the dictionary. The determination step 120 further comprises the transformation of the initial structured base into a graph. The determination step 120 further comprises the calculation of the Shannon entropy associated with each daughter class of the graph. The determination step 120 further comprises the evaluation of the percentage of daughter classes the Shannon entropy of which is greater than a respective value (fifth predefined value). Such actions implemented during the determination step 120 are preferentially as explained hereinabove with reference to the determination module 35.

The precision indicator comprises the percentage of words of the initial structured base 32 appearing in the dictionary, the percentage of words of the initial structured base 32 having a single meaning in the dictionary, and the percentage of daughter classes the Shannon entropy of which is greater than the respective value (fifth predefined value).

If, during the determination step 120, one of the determined indicators is the relevance indicator, the determination step 120 comprises obtaining the artificial intelligence model trained to: receive a scenario and to determine a logical rule combining the values of the set of values leading to the action of said scenario, and to quantify the importance of each value in the action taken. The artificial intelligence model is preferably an LTN model. The determination step 120 further comprises the application of said artificial intelligence model to each scenario of the initial structured base 32, in order to obtain, for each value of each set of values, an importance quantifier in the action of said scenario. Preferentially, each importance quantifier is associated with a respective item of knowledge derived from the scenario, i.e. a pair of class instance and corresponding value. The determination step 120 further comprises the calculation of the proportion of values of the sets of values for which the importance quantifier is less than a respective threshold, i.e. the sixth predefined threshold. Such actions implemented during the determination step 120 are preferentially as explained hereinabove with reference to the determination module 35.

The relevance indicator then comprises said proportion of values of the sets of values for which the importance quantifier is less than the respective threshold, i.e. the sixth predefined threshold.

The enrichment method 100 further comprises a comparison step 130, during which each determined indicator is compared with at least one respective threshold, as explained hereinabove.

If the result of the comparison is negative, i.e. if the comparison of at least one indicator with the respective threshold returns a negative result, the enrichment process comprises a step 140 of sending a command to enrich the initial structured database 32 in order to form the enriched structured database, called the enriched structured base, comprising a larger number of objects than the initial structured base 32.

The steps of obtaining 110, determining 120, comparing 130 and, where appropriate, sending 140 are preferentially reiterated as long as the result of the comparison is negative. The enriched structured base of one iteration being the initial structured base 32 of the next iteration. The structured database obtained at the end of the iterations, i.e. after the first iteration for which the result of the comparison is positive, is called the validated structured base 95.

Preferentially, when the result of the comparison is positive, then the initial structured base 32 is validated and becomes the validated structured base. The enrichment method 100 comprises an import step 150 during which the sending module 45 sends the validated structured base 95 to the interaction device 25.

The enrichment phase 100 then preferentially ends.

The operating phase 200 is e.g. implemented by the interaction device 25.

Preferentially, the operating phase 200 is implemented during a flight of the aircraft 15, the validated structured base 95 being stored e.g. in the second memory 80.

At an instant during the flight of the aircraft 15, the pilot of the aircraft 15 wishes to obtain information from the validated structured base 95.

The operating phase 200 comprises a step 210 of reception of the request from the pilot of the aircraft 15, e.g. via the keyboard 67 or any other means enabling the pilot to send a request to the interaction device 25.

The operating phase 200 further comprises a step 220 of selecting objects from the validated structured base in response to the request received, preferentially as described hereinabove.

Optionally, during the selection phase 220, the interaction device 25 generates the piloting instruction in response to the request from the selected objects.

The operating phase 200 further comprises a step 230 of sending the piloting instruction generated from the selected objects, to one amongst: The pilot of the aircraft 15 and an actuator of the aircraft 15.

For example, if the flight instruction is sent for the pilot, same is displayed on the display screen 65. The pilot then decides whether or not to implement the piloting instruction. Conversely, if the piloting instruction is sent to an actuator of the aircraft 15, said instruction takes the form of a piloting command which is directly implemented by said actuator. The actuator is e.g. an engine of the aircraft 15, a control surface or any other type of actuator.

Preferentially, the operating phase 200 is reiterated on the basis of a new request from the pilot.

The present invention thus makes it possible to guarantee that the structured database used as assistance to piloting is suitable for use by guiding the enrichment thereof, i.e. the construction thereof, by different indicators, also called metrics.

1. A method for enriching a structured database intended for assisting a pilot of an aircraft in decision-making, the method being implemented by an electronic enrichment device and comprising the following steps:
obtaining an initial structured database, known as the initial structured base, comprising a plurality of objects including:
a plurality of classes,
a plurality of data, and
semantic links associating each datum with at least one class,
each datum and/or each class comprising one or a plurality of words,
determination of at least two indicators from the group of indicators consisting of:
a frequency indicator quantifying the frequency of occurrence of each word in the initial structured base,
an interconnection indicator representative of a distribution of semantic links in the initial structured base,
a relevance indicator quantifying the usefulness of the data in the initial structured database,
a precision indicator quantifying the polysemy of each word of the initial structured base,
comparison of each determined indicator with at least one respective threshold,
if the result of the comparison is negative, sending an enrichment command of the initial structured base to form an enriched structured database, called enriched structured base, comprising a larger number of objects than the initial structured base.

2. The method according to claim 1, wherein the step of determination of the indicators comprises determining at least three indicators from the group of indicators, the step of determination of indicators preferentially including the determination of each indicator from the group of indicators.

3. The method according to claim 1, wherein one of the indicators determined during the determination step is the frequency indicator, the determination step comprising:
the calculation of Shannon entropy associated with each word of the initial structured base,
the evaluation of the percentage of words the Shannon entropy of which is greater than a respective value,
the application of a statistical test to Shannon entropies calculated to obtain a p-value and a similarity percentage,
the quantity of information indicator comprising:
the percentage of words the Shannon entropy of which is greater than the preset value,
the p-value, and
the similarity percentage.

4. The method according to claim 1, wherein one of the indicators determined in the determination step is the interconnection indicator, the determination step comprising:
the calculation of the proportion of the number of classes in the initial structured base comprising an explanatory comment on the content of the class,
the calculation of the number of semantic links linking each class to a datum in the initial structured base,
the evaluation of the number of classes linked to data by a number of semantic links less than a respective first value or greater than a respective second value,
the calculation of a modularity value of the classes of the initial structured base, the interconnection indicator comprising:
the number of classes in the initial structured base comprising an explanatory comment of the content of the class,
the number of classes linked to data by a number of semantic links less than the respective first value or greater than the respective second value, and
the modularity value of the classes.

5. The method according to claim 1, wherein one of the indicators determined in the determination step is the precision indicator, the determination step comprising:
obtaining a dictionary comprising a plurality of words and, for each word, at least one meaning,
the comparison of each word of each class of the initial structured base with the words of the dictionary,
the calculation of a percentage of words from the initial structured base appearing in the dictionary,
among the words appearing in the dictionary, the calculation of a percentage of words with a single meaning in the dictionary,
the transformation of the initial structured base into a graph, the graph comprising a central class, called the parent class, linked to a plurality of classes, called the daughter classes,
the calculation of Shannon entropy associated with each daughter class,
the evaluation of a percentage of daughter classes the Shannon entropy of which is greater than a respective value,
the precision indicator comprising:
the percentage of words from the initial structured base that appear in the dictionary,
percentage of words in the initial structured base that have a single meaning in the dictionary,
the percentage of daughter classes the Shannon entropy of which is greater than the respective value.

6. The method according to claim 1, wherein the initial structured base comprises a plurality of scenarios each comprising a set of values and an action taken by the pilot of the aircraft in the presence of the set of values, each value of the set of values being a numerical value of a datum of the initial structured base,
one of the indicators identified during the determination step being the relevance indicator, the determination step comprising:
obtaining an artificial intelligence model trained to receive a scenario and to determine a logical rule combining the values of the set of values leading to the action of said scenario, and to quantify the importance of each value in the action taken,
application of said artificial intelligence model to each scenario of the initial structured base, in order to obtain, for each value of each set of values, an importance quantifier in the action of said scenario,
calculation of the proportion of values in sets of values for which the significance quantifier is below a respective threshold,
the relevance indicator comprising:
said proportion of values of the sets of values for which the significance quantifier is less than the respective threshold.

7. The method according to claim 1, wherein, following the step of sending an enrichment command, the steps of obtaining, determining, comparing and, where appropriate, sending, of the method are reiterated as long as the result of the comparison is negative,
the enriched structured base of one iteration being the initial structured base of the following iteration,
the structured database obtained at the end of the iterations being called the validated structured base.

8. The method according to claim 7, wherein the method comprises, if the result of the comparison is positive, a step of importing the validated structured base, into an electronic device for interaction with the pilot of the aircraft, for the use thereof during an aircraft mission.

9. A method for assisting the piloting of an aircraft starting from an initial structured database, called the initial structured base, the method comprising an enrichment phase and an operating phase,
the enrichment phase comprising an enrichment of the initial structured base by application of an enrichment method according to claim 1,
the operating phase being implemented by an electronic device for interaction with the pilot of the aircraft, the electronic device for interaction comprising the structured database resulting from the enrichment phase, called the validated structured base, and comprising the following steps:
reception of a request from the pilot of the aircraft,
selection of objects, from the validated structured base, in response to the request received,
transmission of a flight instruction elaborated from the selected objects, to one amongst: the pilot of the aircraft and an actuator of the aircraft.

10. A non-transitory computer-readable medium including a computer program comprising instructions which, when executed by a computer, implement a method according to claim 1.

11. An electronic device for enriching a structured database intended to assist a pilot of an aircraft in decision-making, the electronic enrichment device comprising:
an obtaining module configured to obtain an initial structured database, called initial structured base, comprising a plurality of objects including:
a plurality of classes,
a plurality of data, and
semantic links associating each datum with at least one class,
each datum and/or each class comprising one or a plurality of words,
a determination module configured to determine at least two indicators from the group of indicators consisting of:
a frequency indicator quantifying the frequency of occurrence of each word in the initial structured base,
an interconnection indicator representative of a distribution of semantic links in the initial structured base,
a relevance indicator quantifying the usefulness of the data in the initial structured database,
a precision indicator quantifying the polysemy of each word of the initial structured base,
a comparison module configured to compare each determined indicator with at least one respective threshold,
a sending module configured to, if the result of the comparison is negative, send a command to enrich the initial structured base in order to form an enriched structured database, called enriched structured base, comprising a larger number of objects than the initial structured base.
